(19) United States
(12) Patent Application Publication
(10) Pub. No.: US 2018/0260828 A1
(43) Pub. Date: Sep. 13, 2018

(54) SYSTEM FOR PREVENTING WEBSITE REDIRECTION

(71) Applicant: Lucid Holdings, LLC, New Orleans, LA (US)

(72) Inventors: Vignesh Krishnan, New Orleans, LA (US); Patrick Comer, New Orleans, LA (US); William Bradley, New Orleans, LA (US)

(21) Appl. No.: 15/456,369

(22) Filed: Mar. 10, 2017

(51) Int. Cl. G06Q 30/02

(52) U.S. Cl. CPC G06Q 30/0203; G06Q 30/0255; G06Q 30/0254; G06Q 30/0204

(57) ABSTRACT

Systems and methods may reducing website redirection for surveys. A method may include receiving, at a host server, an indication via an application programming interface (API), the indication including a request for survey. Demographic questions may be supplied and at least one may be answered. The method may include determining whether a respondent to the demographic questions is qualified for a survey, and sending information including a result of the determination.

### BACKGROUND

Many companies perform market research to determine consumer reaction to products, advertising, costs, or other aspects of consumer-facing business. One method of traditional market research that has recently increased in popularity is surveys due to the ubiquity of the internet. However, performing surveys on the internet present some specific, technical problems that are not present in the traditional offline methods. These problems cause inaccuracies and difficulties in obtaining or retaining survey takers.

The problems described above are both internet-centric problems arising in the technical areas of how the internet functions as well as being problems specific to surveys. In other words, traditional survey techniques do not suffer from these problems and thus do not offer any solutions. Present internet-based survey techniques do not address these problems.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic diagram for performing surveys in accordance with some embodiments.

FIGS. 2A-2C illustrate example user interfaces for responding to survey, demographic, or targeted product questions in accordance with some embodiments.

FIG. 3 illustrates a flowchart showing a technique for determining demographic information about a respondent in accordance with some embodiments.

FIG. 4 illustrates a flowchart showing a technique for providing survey questions to a respondent in accordance with some embodiments.

FIG. 5 illustrates a flowchart showing a technique for providing targeted product questions to a respondent in accordance with some embodiments.

FIG. 6 illustrates a system for reducing website redirection for surveys in accordance with some embodiments.

FIG. 7 illustrates a flowchart showing a technique for reducing website redirection for surveys in accordance with some embodiments.

FIG. 8 illustrates generally an example of a block diagram of a machine upon which any one or more of the techniques (e.g., methodologies) discussed herein may perform in accordance with some embodiments.

### DETAILED DESCRIPTION

As discussed above, performing surveys on the interne presents some specific, technical problems that are not present in traditional offline methods and these problems often cause difficulties in obtaining or retaining survey takers. Companies wish to perform surveys in order to solicit feedback from customers or potential customers, determine buying habits, effectiveness of advertisements, triage, or for a variety of other reasons. When a company decides to pursue a survey, the company must determine survey questions to ask and find respondents to answer the survey questions. For improved results, companies typically want respondents to qualify or fit within one more demographic categories, such as those related to age, gender, income, marriage status, number of children, recently viewed advertisements, location, purchased products, intent to purchase products, stores frequented, or the like.

Presently, companies use an intermediary host to connect with the respondents and receive survey answers from respondents that are qualified for the survey (e.g., based on demographic answers given by the respondents). For example, a company may contact a host with a list of requirements or respondent qualifications for participation in a survey. The host may find qualified respondents via a third party market researcher. The third party market researcher solicits respondents and connects them with the host, which may then ask the respondents demographic questions. Once qualified respondents are determined, the host may then connect the qualified respondents with the company (or an affiliate conducting the survey) to respond to the survey questions. This may be a cumbersome process and some otherwise qualified respondents may quit the process before completion.

An example work flow includes receiving, at a host server, respondent qualifications from a buyer (i.e., a company requesting survey results) and a link to a survey, hosted at a survey website, which may be contracted out by the buyer or may be hosted by the buyer. The host server may then reach out to a survey seller (e.g., a third party website, such as one owned by a market research company, that has access to potential respondents, a third party app, another publisher, or the like). The survey seller indicates respondents are available to the host server. The third party website, third party app, another publisher, or the like, then directs the indicated respondents to a website controlled by the host server, which then sends demographic questions based on the respondent qualifications to the survey seller at the website controlled by the host server. After receiving answers to the demographic questions, the host server determines which, if any, respondents are qualified and sends a link to survey questions to those respondents who are qualified. The respondents are thus directed to another website, such as a survey website that hosts the survey on behalf of the buyer. After completing the survey, the respondents may be redirected back to the survey seller's third party website, third party app, another publisher, or the like, or the trail may end. The results are then sent to the buyer by the survey website, and the host server may not see the survey results.

The qualified respondents, in the process described above, are directed and redirected to at least three separate websites, namely the survey seller website to identify themselves as respondents, the host server website to answer demographic questions, and then the survey website to answer survey questions. At each of the redirections (e.g., to the host server website or to the survey website), qualified respondents are sometimes lost. In an example, respondents quit the process before completion because they do not know or trust the website of the host server or the survey website, or are confused by the redirection.

Systems and methods are described herein for reducing website redirection for surveys. The systems and methods described herein may eliminate one or more of the redirections described in the process above. For example, techniques described herein may be used to reduce redirection to a host server website by supplying demographic questions to be answered by respondents directly on a third party website, third party app, another publisher, or the like. In an example, techniques described herein may be used to reduce redirection to a survey website by supplying survey questions to the host server website or the third party website, third party app, another publisher, or the like. In an example, additional trust with respondents may be created by allowing respondents to participate in part of or the entirety of a survey process on a trusted third party website (e.g., not a market research website), third party app, another publisher, or the like.

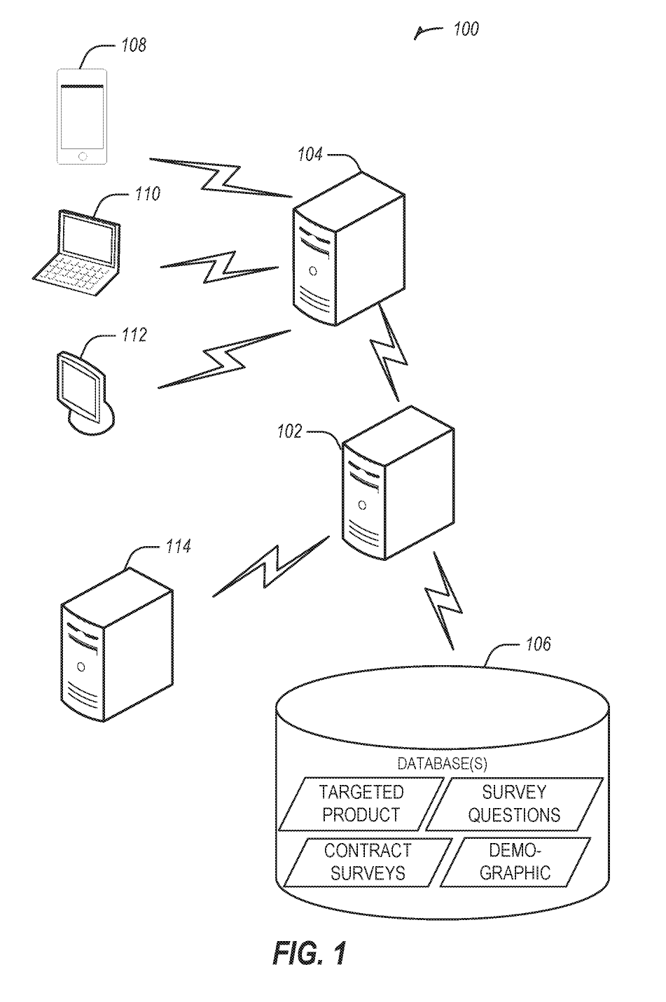

FIG. 1 illustrates a schematic diagram 100 for performing surveys in accordance with some embodiments. The schematic diagram 100 includes a host server 102. The host server 102 is in communication with a third party server 104 that communicates with a consumer device, such as a mobile device 108, a desktop computer 110, or a laptop 112. The host server 102 may communicate with a buyer server 114. The host computer 102 may include or communicate with a database 106. In some examples, the components of FIG. 1 may be communicatively coupled through one or more computer networks.

The database 106 may include information about topics related to surveys. For example, the database 106 may include a targeted product database with targeted product questions, information about demographics of potential respondents for targeted product questions, information about past respondents, information about advertisements shown, buyers or requesters of targeted product respondent answers, etc. Targeted product questions may be questions directed to a respondent based on: a specific interaction with an advertisement, engagement with an advertisement or advertising materials, or a specific advertisement. The targeted product questions may have associated demographic or other requirements for a respondent, such as requiting a particular engagement, interaction, level of awareness, or viewing of an advertisement or product.

The database 106 may include survey questions, including survey answers, respondent information tied to survey answers, metadata, etc. The database 106 may include contracts for surveys, including information from buyers related to requests for particular demographics of respondents, prices, timing, etc. The database 106 may include demographic information about potential respondents, past respondents, desired respondents, etc.

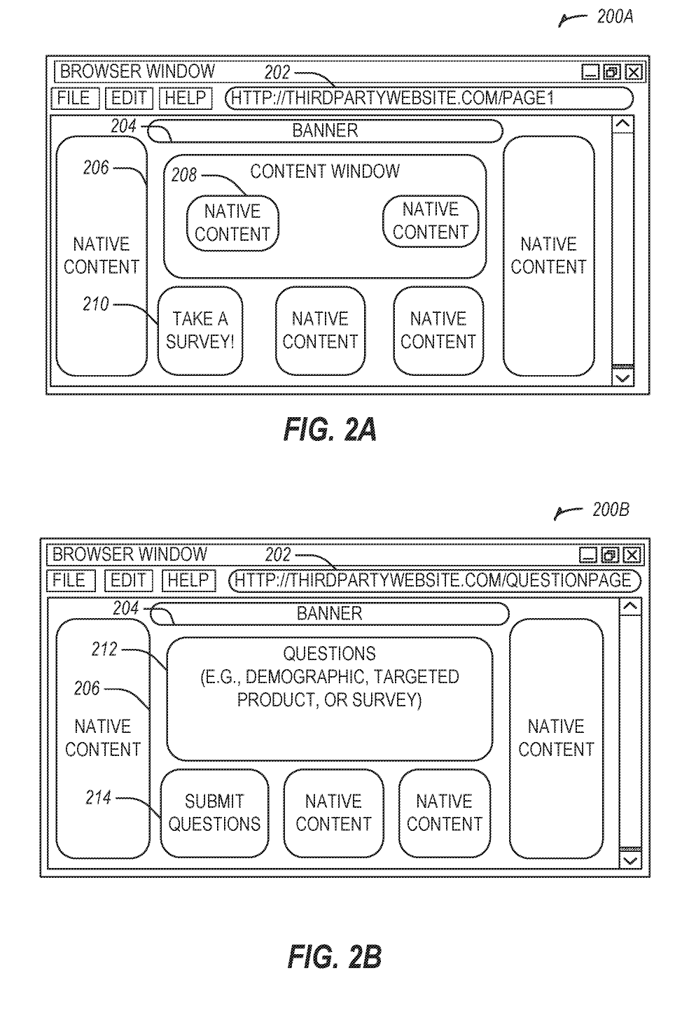

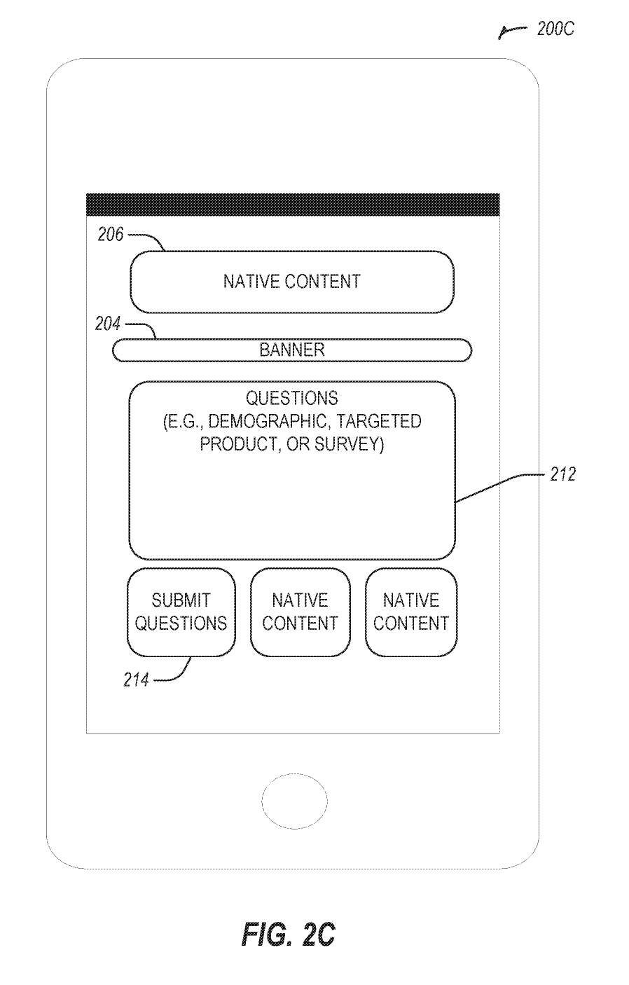

FIGS. 2A-2C illustrate example user interfaces for responding to survey, demographic, or targeted product questions in accordance with some embodiments. The first example website 200A includes a plurality of page elements, such as native content (e.g., 206 and 208), a banner 204, advertisements, or the like. Native content (e.g., 206 and 208) may include text, a pattern, a color, a sidebar, a footer, a header, an advertisement, etc. The website 200A includes a selectable survey indication 210 for taking a survey. In an example, the selectable survey indication 210 may be represented on the website 200A using colors, layout options, sizing, etc., in line with the native content (e.g., 206 or 208). For example, the selectable survey indication 210 may appear to be a native part of the website 200A, rather than a link or advertisement that would take a user outside the website 200A.

Once selected, the selectable survey indication 210, or other components of the website 200A, may change as the website 200A directs a user to a second example website 200B (e.g., native content 208 disappears). Some content (e.g., in the example shown in websites 200A and 200B native content 206 and the banner 204) may stay on the website 200B or be modified rather than removed. The continuity of one or more content items, such as the banner 204 may further emphasize to a user that the website 200B has a similar “feel” to website 200A or may further emphasize to a user that both website 200A and 200B are hosted, owned, or operated by a coherent entity. Websites 200A and 200B include a universal resource locator (UAL) bar 202. The URL bar 202 includes example URLs for website 200A, namely http://thirdpartywebsite.com/page1, and for website 200B, namely http://thirdpartywebsite.com/questionpage. Using the same base URL with different pages may further confirm the continuity of the survey process and persuade a user that the user has not been redirected to another website to take the survey. For example, the website 200A may prevent or refrain from redirecting the user to another website (e.g., a website on a different domain than website 200A).

In website 200B, a content window and native content 208 have been replaced by a questions box 212. The questions box 212 may be used to ask questions of a user, such as demographic questions, targeted product questions, or survey questions. The questions box 212 may be rendered uniquely for each of these types of questions or may be consistent among each type. The selectable survey indication 210 has also been replaced in website 200B by a selectable question submission indication 214. The selectable question submission indication 214 may be used to submit questions (e.g., demographic questions, targeted product questions, or survey questions). The selectable survey indication 210 may be removed, even if the selectable question submission indication 214 does not replace it. In another example, the selectable question submission indication 214 may be located at a different position within website 200B. For example, the selectable question submission indication 214 may be located within the question box 212.

Answers may be submitted to the questions in the question box 212 within the question box 212 or in another area. When the selectable question submission indication 214 is selected, answers that were submitted to questions in the question box 212 may be sent to a host or remote server. Additional questions may be received and replace the previous questions if demographic questions indicate a targeted product or survey are appropriate, questions related to the targeted product or the survey may be provided). When all questions have been answered, the website 200B may direct a user to a different website (e.g., a website indicating “thanks” for answering questions, a reward website, etc.), or may direct the user back to the original website 200A.

The user interface in FIG. 2C is displayed in an app on a mobile device 200C. The app may be dedicated to conducting surveys or may conduct surveys in addition to other activities. The mobile device 200C may be used to display, on the app, similar features to the website 200B, such as the banner 204, the native content 206, the questions box 212, and the submission indication 214. The app may also be used to present the selectable survey indication 210 for taking a survey, as in FIG. 2A. The survey content (e.g., the questions box 212, the submission indication 214, or the selectable survey indication 210) may be presented within the app including using colors, styles, presentation types, or the like of the app for an integrated experience. By presenting the survey content within the app, the user interface may prevent redirection to a different app (e.g., a web browser) on the mobile device 200C.

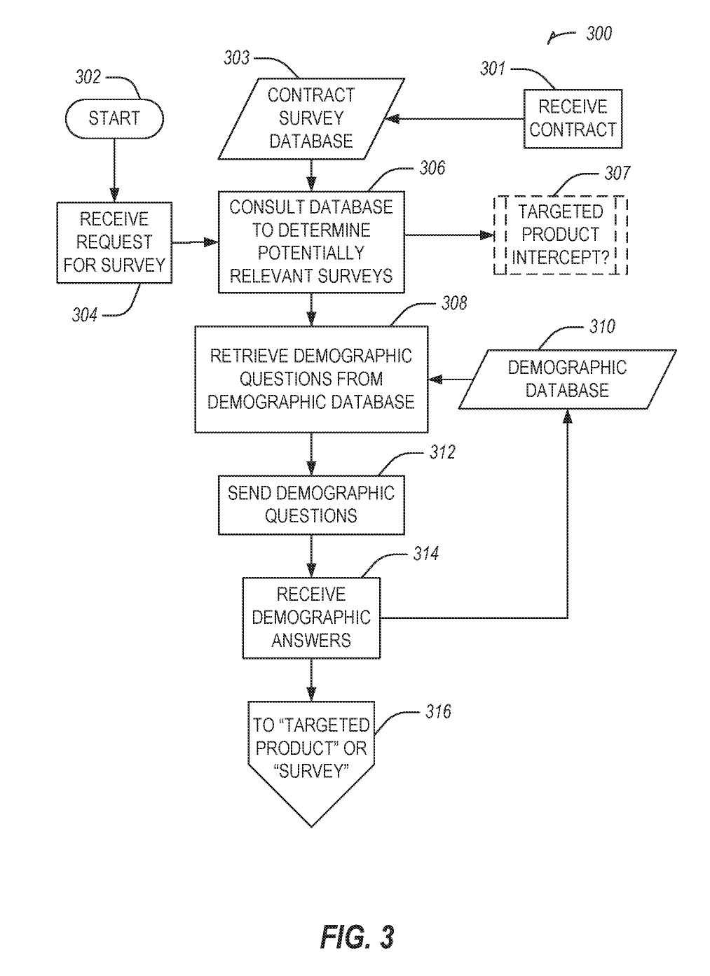

FIG. 3 illustrates a flowchart showing a technique 300 for determining demographic information about a respondent in accordance with some embodiments. After starting at 302, the technique 300 includes an operation 304 to receive a request for a survey, such as from a user of a third party website. The request may include additional information, such as a time limit for the survey, limited demographic information (e.g., from a cookie, such as that an advertisement has been displayed or selected), payment information (e.g., asks), or other identifying information.

The technique 300 includes an operation 306 to consult a database to determine potentially relevant surveys. For example, operation 306 may determine whether surveys are available, or whether surveys are available based on the limited information received in operation 304 (e.g., whether surveys are available for a location of an IP address of a user of a website sending the request for a survey). The database may he a contract survey database 303 that may receive contracts from 301. The contracts may be received from buyers requesting surveys be conducted. The contracts may include demographic or other requirements, as well as payment or reward bids. The contracts may be parsed and the information from the contracts may be stored in the contract survey database 303. In an example, before performing operation 308, the technique 300 may optionally include determining whether a targeted product intercept should occur at operation 307.

The technique 300 includes an operation 308 to retrieve demographic questions from a demographic database 310, such as based on identified surveys or potentially relevant surveys from operation 306. The demographic database 310 may include demographic questions, such as those parsed from contract data received and stored in the content survey database 303. The demographic database 310 may include answers to demographic questions (e.g., previously stored answers). The demographic database 310 may include information about a user requesting a survey (in operation 304), by using identifying information of the user in a cookie or other identification technique and matching with previously stored information about the user in the demographic database 310.

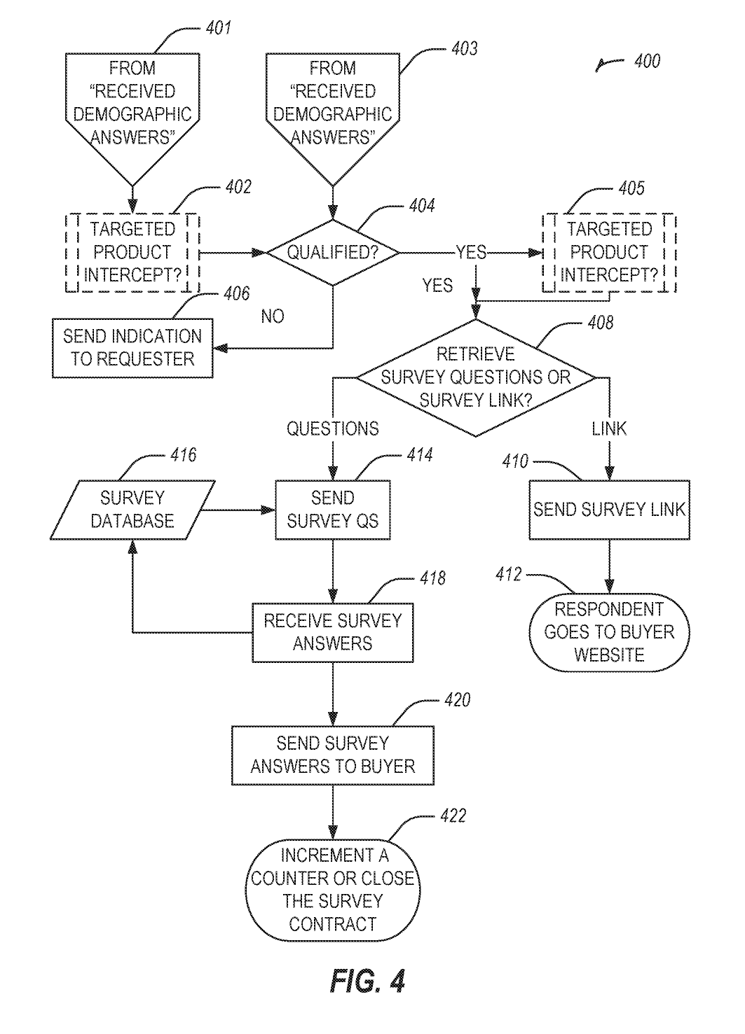

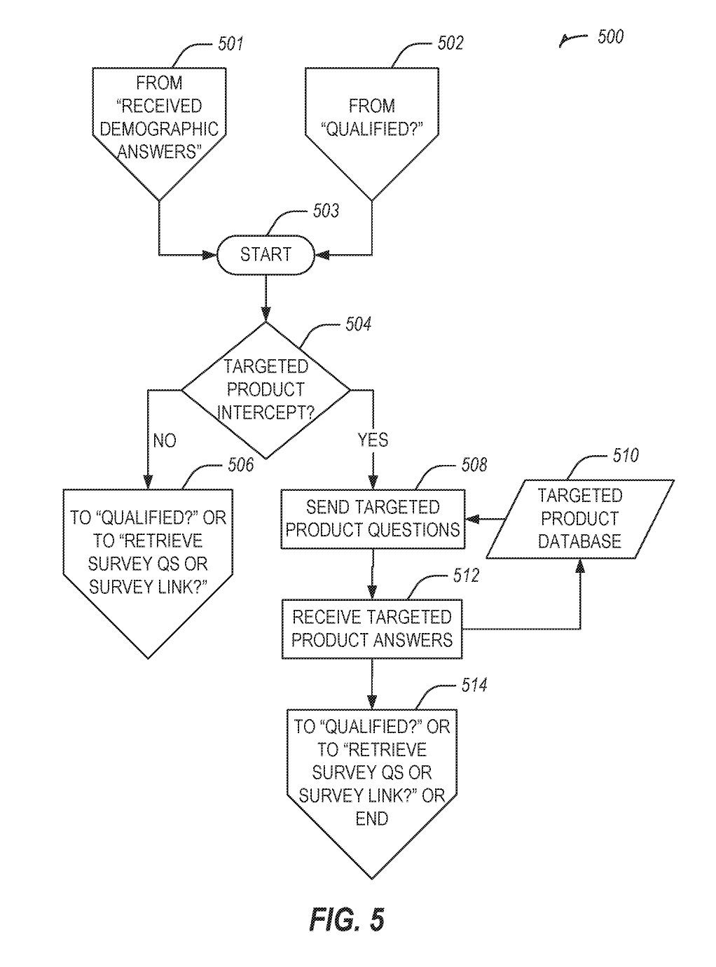

The technique 300 includes an operation 312 to send demographic questions, such as to the requesting website (from operation 304). Operation 312 may be performed in response to determining that there are demographic questions or surveys that may be potentially relevant. If demographic questions or surveys are not found to ask, the technique 300 may send a response indicating such to the requesting website or may end. If the demographic database 310 includes sufficient information to qualify a user for a survey without asking additional demographic questions (e.g., using cookies), the remaining operations may be skipped, and the technique 300 may proceed to other techniques, such as those described below in FIG. 4 or 5.

After the demographic questions are sent in operation 312, the technique 300 includes receiving demographic answers at operation 314. The demographic answers may include one or more answers to the demographic questions sent in operation 312. The demographic answers may be saved in the demographic database 310 (e.g., anonymously for accumulating statistics or to an identified user, such as using cookies). The technique 300, after receiving the demographic answers in operation 314 may proceed to additional techniques at 316 for determining whether a user is qualified for a targeted product or a survey.

FIG. 4 illustrates a flowchart showing a technique 400 for providing survey questions to a respondent in accordance with some embodiments. The technique 400 may start at 401 or 403, such as depending on whether a targeted product intercept technique is to be applied. For example, when a buyer has targeted product questions, the technique 400 may start at 401 and determine whether to intercept the survey with targeted product questions at operation 402. Operation 402 may include determining whether a user is qualified for targeted product questions and asking the targeted product questions and is described in further detail below and in FIG. 5. In an example, when a buyer does not have targeted product questions, or targeted product questions are not available, the technique 400 starts at 403. After the targeted product intercept determination or technique is completed at operation 402, the technique 400 may proceed to determining qualification at 404.

In an example, the technique 400 continues from technique 300 described above, after receiving answers to demographic questions. The technique 400 includes an operation 404 to determine whether a user is qualified for a survey, such as based on the answers given to the demographic questions. When it is determined that the user is not qualified for any surveys, an indication may be sent to a requestor website at operation 406. The indication may include information related to the lack of available surveys. The indication may include a first payment amount or value to be sent to an owner of the requestor website based on the attempted survey (e.g., a first payment for sending demographic answers, even though no survey was completed).

When it is determined that the user is qualified for one or more surveys, a second determination may be made at operation 405 whether to intercept the technique 400 with targeted product questions. In another example, operation 405 may be skipped. The qualified user determination at 404 proceeds to a determination at 408 for whether to retrieve survey questions or a survey link. Depending on predetermined setup among the requestor website, a host server, a surveying website, or a buyer, survey questions to send directly to the requestor website for display directly on the requestor website) or a link (e.g. to the surveying website) may be sent to the requestor website for display. In another example, the determination at 408 may be preset and skipped, with questions or a link sent in response to the determination of qualification at 404.

When it is determined at 408 (or predetermined) that a link is to be sent, the technique 400 may send a survey link at operation 410. For example, a survey link may be sent to the requestor website so that the user may click on the link and be directed to a buyer website or a surveying website at operation 412, ending the technique 400. The survey questions may be then answered by the user at the buyer website or the surveying website. At the end of the technique 400, in an example, a second payment amount or value may be sent to the requestor website (or stored in a database for later accounting).

When it is determined at 408 (or predetermined) that survey questions are to be sent to the requestor website directly for display on the requestor website, these questions may be sent at operation 414. The requestor website may ask the user to respond to the survey questions (see, for example, the website 200B described above in FIG. 2B). The survey questions may be retrieved from a survey database 416. The survey database 416 may include survey questions, such as those parsed from contracts sent by buyers (e.g., the contracts parsed to determine the contract information or the demographic information stored at the contract survey database 303 or the demographic database 310 respectively). The survey database 416 may send survey questions in response to the technique 400 requesting survey questions for a particular survey.

The technique 400 includes an operation 418 to receive the survey answers. The survey answers may be received from the requestor website based on user responses to the survey questions. The survey answers may be stored in the survey database 416. After the survey answers are received, the survey database 416 may be accessed by the buyer to retrieve the survey answers. In an example, the survey answers may be automatically sent to the buyer at operation 420. In an example, the survey answers may be identified as corresponding to demographic information (e.g., stored in the demographic database 310), which may also be retrieved by the buyer or automatically sent along with the survey answers when requested by the buyer.

The technique 400 may end by incrementing a counter or closing the survey contract at operation 422. For example, the counter may be compared to a threshold to determine if a threshold number of users have answered the survey questions. The threshold or counter may be based on demographics (e.g., a first counter and threshold for a first demographic and a second counter and threshold for a second demographic), such as age ranges, gender, location, user preferences, etc. At operation 422, a payment amount or value may be sent to the requestor website or noted. This payment amount or value may be the same as the second payment amount or value or may be a third payment amount or value. In an example, hosting the survey questions may be more valuable for a requestor website (e.g., since the user stays on the requestor website for the duration and may be directed to another part of the requestor website after completion of the survey), and the payment may be lowered accordingly. In another example, hosting the survey questions may be more burdensome for the requestor website (e.g., if the requestor website is a small website and does not have sufficient resources to easily host the questions) and the payment may be increased accordingly. In yet another example, payment amounts or values may be preselected by the buyer.

FIG. 5 illustrates a flowchart showing a technique 500 for providing targeted product questions to a respondent in accordance with some embodiments. The technique 500 may originate at 503 organically, or may start in response to a targeted product intercept query (e.g., from operations 402 or 405 of the technique 400 at 501 or 502, respectively). The organic origination may be in response to a user engaging with an advertisement, or being identified (e.g., using cookies) as having previously engaging with an advertisement.

The technique 500 includes an operation 504 to determine whether to ask targeted product questions. The determination at operation 504 may be based on demographics of the user, availability of targeted product questions, prior engagement with an advertisement, prior targeted product questions administered to the user (or previous receipt of answers to prior targeted product questions), buyer preferences, survey importance, or the like. When the determination is to not proceed with the targeted product intercept, the technique 500 may end and may return at 506 to an appropriate place in the technique 400, or the like. The determination to not proceed may be based on lack of availability of targeted product questions, prior responses to targeted product questions, lack of engagement with an advertisement, high survey importance, or the like.

The determination to proceed with the targeted product intercept may be based on demographic information matching targeted product requirements, a cookie indicating that the user has engaged with the advertisement, an available targeted product, etc. The technique 500 includes an operation 508 to send the targeted product questions, such as to the requester website in response to the determination to proceed. The targeted product questions may be retrieved from a targeted product database 510. Answers to the targeted product questions may be received at operation 512 and stored in the targeted product database 510. The targeted product database may include identifying information of the user, such as based on cookies, for corresponding targeted product answers. The identifying information may include demographic information as well as information about engagement with an advertisement (e.g., when the advertisement was accessed or selected, a browser used to engage with the advertisement, etc.).

The targeted product answers may be sent to the buyer or stored in the targeted product database 510 for later retrieval by the buyer. The technique 500 may then end at 514, and may return to an appropriate point in the technique 400, where applicable. The targeted product questions may replace survey questions for the user or may be asked in addition to the survey questions, provided that the user is qualified for both.

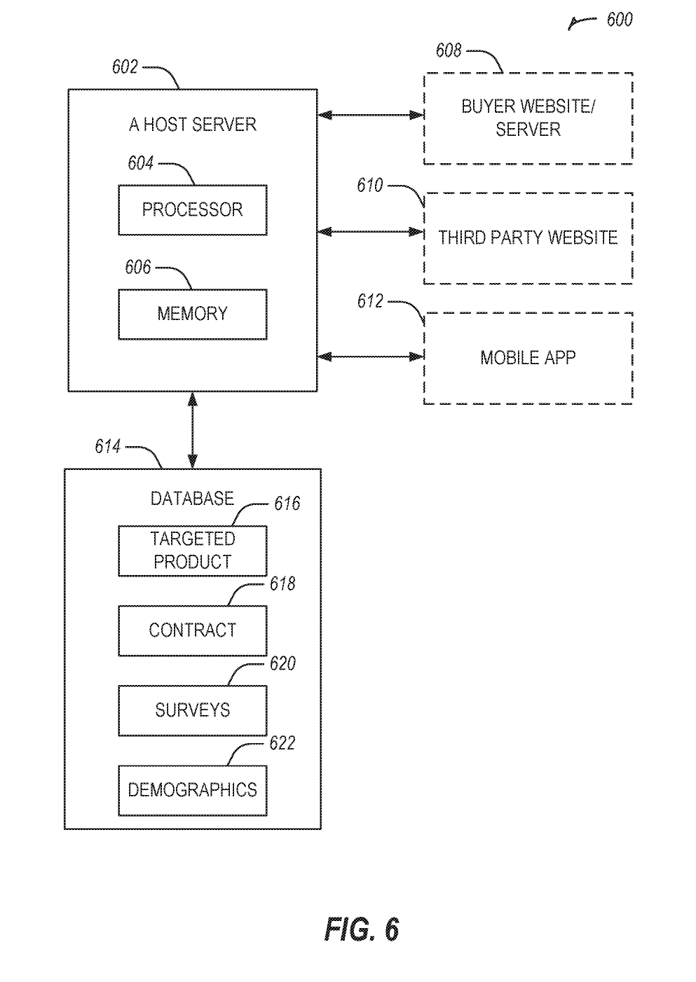

FIG. 6 illustrates a system 600 for reducing website redirection for surveys in accordance with some embodiments. The system 600 includes a host server 602 and a database 614 (which may include a plurality of databases). The host server 602 may be in communication with an optional buyer website or server 608, an optional third party website 610 (e.g., also referred to herein as a requestor website, which may not be a dedicated market research website; for example, the requestor website may be unrelated to market research, but may allow respondents to initiate a request for surveys) or an optional mobile app 612. In an example, the third party website 610 and the mobile app 612 may be used interchangeably for purposes of communication with the host server (although presentation of information to a user, such as a display device, may differ). In an example, an application programming interface (API) may be used to communicate with the third party website 610, the mobile app 612, or the buyer website or server 608.

The database 614 may include a targeted product database 616, a contract database 618, a survey database 62.0 or a demographics database 622. The database 614 may include references such that data stored in one of the sub databases may be identified as corresponding with data stored in another of the sub databases (e.g., survey answers may correspond with demographic information or targeted product answers may correspond with cookie information identifying a user). The host server 602 may be in communication with the database 614 to retrieve and store information, such as demographic information, survey contract information, targeted product questions, survey questions, targeted product demographic requirements, payment information, counters, thresholds, or the like.

The host server 602 may include a processor 604 and memory 606. The processor 604 may be communicatively coupled to the memory 606. The memory 606 may store instructions, which when executed by the processor 604, cause the processor 604 or the host server 602 to perform operations, such as those described herein. For example, the host server 602 may perform operations to receive an indication from the third party website 610 or the mobile app 612 via an API, the indication including a request for surveys. In an example, the survey questions may be stored at the buyer website or server 608.

The host server 602 may supply demographic questions to the third party website 610 or the mobile app 612 from the host server 602 (e.g., from the database 614) via the API, the demographic questions supplied to be integrated into a webpage of the third party website for display in a Graphical User Interface (GUI) to a respondent. The host server 602 may receive an answer to at least one of the demographic questions provided by the respondent on the third party website 610 or on the mobile app 612, the answer sent via the API to the host server 602.

The host server 602 may determine whether the respondent is qualified for a survey using the answer, such as by consulting the database 614 for demographic requirements of surveys. In an example, to determine the that the respondent is qualified for the survey, the processor 604 may determine that answers supplied by the respondent to all of the demographic questions match survey qualification criteria and indicate that the respondent is qualified for the survey.

The host server 602 may send, to the third party website 610 or the mobile app 612, information including a result of the determination. In an example, to send the information, the processor 604 may send, in response to determining that the respondent is qualified, survey questions for the survey to the third party website 610 or the mobile app 612 via the API, the survey questions to be integrated into the webpage or into a second webpage of the third party website 610 or the mobile app 612 for display in the GUI to the respondent. The processor 604 may further receive answers to the survey questions from the third party website 610 or the mobile app 612. In an example, to send the information, the processor 604 may send, in response to determining that the respondent is qualified, a link to the third party website 610 or to the mobile app 612 to allow the respondent access to the survey.

In an example, to send the information, the processor 604 may send, in response to determining that the respondent is not qualified for the survey, a notification to the third party website 610 or the mobile app 612 that the respondent is not qualified. A first transaction cost (e.g., payment amount or value or in-kind trade) may be associated with a respondent that is not qualified. A second transaction cost may be associated with a respondent that is qualified.

In an example, to send the information, the processor 604 may send targeted product questions instead of survey questions in response to determining that the respondent is qualified to answer the targeted product questions using a cookie received from the third party website 610 or the mobile app 612, the cookie corresponding to an advertisement, the targeted product questions including questions about the advertisement. In an example, the processor 604 may automatically create the demographic questions at the host server 602 (which may be stored in the database 614 at the demographics database 622 or the contract database 618), such as by extracting information from a set of requirements (e.g., a contract) supplied by a buyer (e.g., via the buyer website or server 608.

In an example, the host server 602 may receive information from the buyer website/server 608 or from an advertising server at the direction of the buyer website/server 608, The information may include user or device identifying information. For example, the host server 602 may receive the following device IDs: XXYZ, ZZYY, SSWQ, SERE indicating that a user of each of those four devices viewed or interacted with an advertisement (ad impression). The host server 602 may receive a request, including a particular device ID, from the third party website 610 or the mobile app 612 asking if the particular device ID is qualified to take a targeted product survey. In an example, the device ID may be FPPY, in which case the host server 602 may respond to the third party website 610 or the mobile app 612 that the device is on a qualified list (e.g., the list received from the buyer website/server 608). In another example, the third party website 610 or the mobile app 612 may send device ID XXYZ. In this case, the host server 602 may respond that the device ID matches a qualified device ID, and may send the targeted product survey questions, such as via an API. The host server 602 may receive answers to the targeted product survey questions from the third party website 610 or the mobile app 612, such as via an API.

The targeted product survey questions may include demographic questions. In the received answers, additional demographic information may be provided. The provided demographic information may reveal that the user associated with the device II) XXYZ is not qualified for the targeted product survey (e.g., the demographic information indicates the user is above or below an age range or threshold, is a different gender than required, has an incompatible salary response, etc.). In this case, the host server 602 may store the received answers, but not apply them to the targeted product survey questions (e.g., not store them in the targeted product database 616, not send them to the buyer website/server 608, etc.). A different transaction cost may be associated with (and sent to the third party website 610 or the mobile app 612) based on whether the device II) XXYZ is ultimately qualified to take the targeted product survey questions. For example, if the device ID XXYZ is qualified, $1 may be sent to the third party website 610 or the mobile app 612 and if the device ID XXYZ is not qualified, 10 cents may be sent to the third party website 610 or the mobile app 612. The host server 608 may receive a subsequent request for survey questions for the device ID XXYZ. The additional demographic information received from the previous received answers may be leveraged to determine at the host server 602 whether to accept or reject the device ID XXYZ for this new survey.

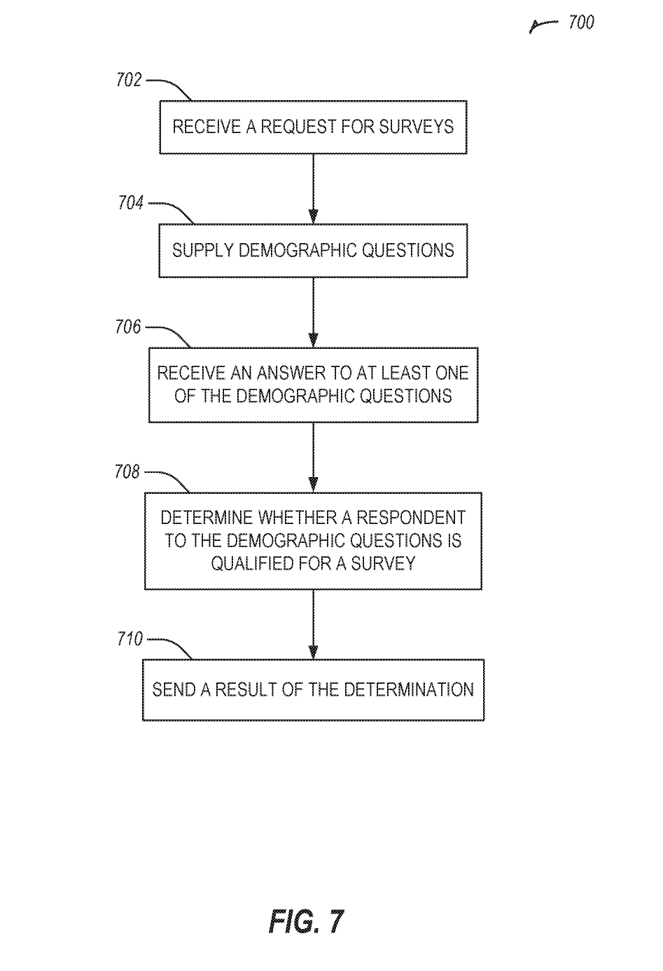

FIG. 7 illustrates a flowchart showing a technique 700 for reducing website redirection for surveys in accordance with some embodiments. The technique 700 includes an operation 702 to receive, such as at a host server, a request for surveys. The request may include an indication from a third party website or a mobile app, such as via an application programming interface (API). The technique 700 includes an operation 704 to supply demographic questions, such as to the third party website or the mobile app from the host server via the API. In an example, the demographic questions may be supplied in a fashion to be integrated into a webpage of the third party website or the mobile app for display in a Graphical User Interface (GUI) to a respondent. The technique 700 includes an operation 706 to receive, such as at the host server, an answer to at least one of the demographic questions. The answer may be provided by respondent on the third party website or the mobile app, and the answer may be sent via the API to the host server.

The technique 700 includes an operation 708 to determine, such as at the host server, whether the respondent is qualified for a survey using the answer. In an example, determining that the respondent is qualified for the survey includes determining that answers supplied by the respondent to all of the demographic questions match survey qualification criteria and indicate that the respondent is qualified for the survey. In an example, the technique 700 includes receiving answers to survey questions from the third party website or the mobile app.

The technique 700 includes an operation 710 to send information including a result of the determination, such as to the third party website or the mobile app. In an example, sending the information includes sending, in response to determining that the respondent is qualified, survey questions for the survey to the third party website or the mobile app via the API, the survey questions to be integrated into the webpage or into a second webpage of the third party website or the mobile app for display in the GUI to the respondent. In an example, sending the information includes sending, in response to determining that the respondent is qualified, a link to the third party website or the mobile app to allow the respondent access to the survey.

In an example, sending the information includes sending, in response to determining that the respondent is not qualified for the survey, a notification to the third party website or the mobile app that the respondent is not qualified. In an example, sending the information includes sending targeted product questions instead of survey questions in response to determining that the respondent is qualified to answer the targeted product questions using a cookie received from the third party website or the mobile app corresponding to an advertisement, the targeted product questions including questions about the advertisement.

In an example, the survey questions are stored at a buyer server and the demographic questions are stored at the host server. In an example, the technique 700 includes automatically creating the demographic questions at the host server by extracting information from a set of requirements provided by a buyer. In an example, a first transaction cost is associated with a disqualified respondent and a second transaction cost is associated with a qualified respondent. In an example, the third party website or the mobile app is not a dedicated market research website.

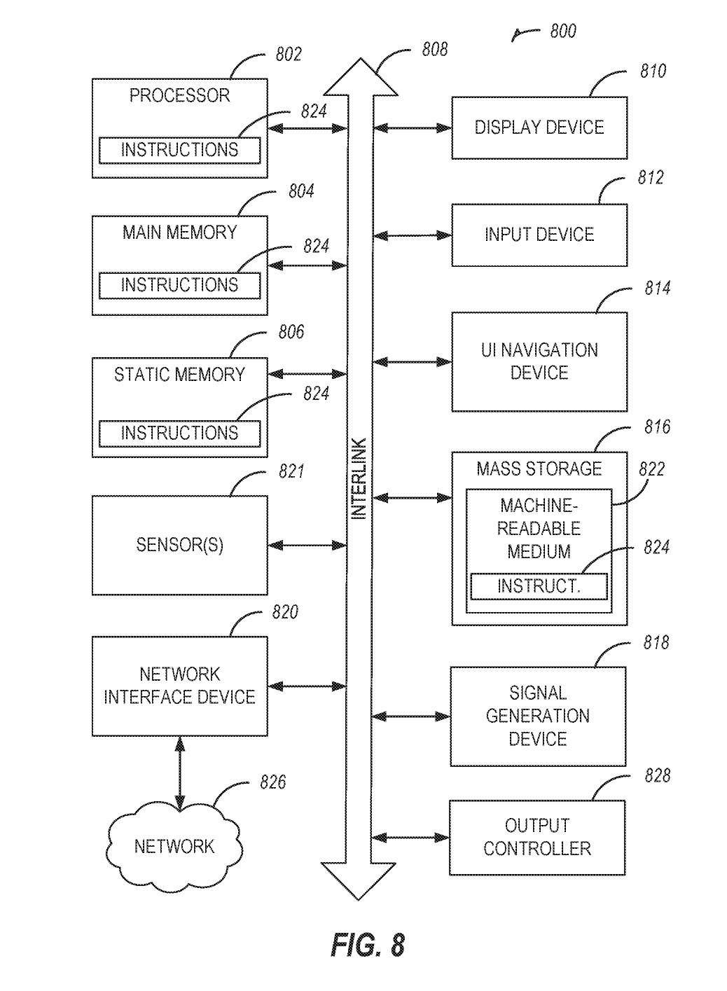

FIG. 8 illustrates generally an example of a block diagram of a machine 800 upon which any one or more of the techniques (e.g., methodologies) discussed herein may perform in accordance with some embodiments. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, alphanumeric input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 that is non-transitory on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Various Notes & Examples

Each of these non-limiting examples may stand on its own, or may be combined in various permutations or combinations with one or more of the other examples.

Example 1 is a method for reducing website redirection for surveys comprising: receiving, at a host server, an indication from a third party website via an application programming interface (API), the indication including a request for surveys; supplying demographic questions to the third party website from the host server via the API, the demographic questions supplied to be integrated into a webpage of the third party website for display in a Graphical User Interface (GUI) to a respondent; receiving, at the host server, an answer to at least one of the demographic questions provided by the respondent on the third party website, the answer sent via the API to the host server; determining, at the host server, whether the respondent is qualified for a survey using the answer; and sending, to the third party website, information including a result of the determination.

In Example 2, the subject matter of Example 1 optionally includes wherein sending the information includes sending, in response to determining that the respondent is qualified, survey questions for the survey to the third party website via the API, the survey questions to be integrated into the webpage of the third party website for display in the GUI to the respondent.

In Example 3, the subject matter of Example 2 optionally includes receiving answers to the survey questions from the third party website.

In Example 4, the subject matter of any one or more of Examples 1-3 optionally include wherein sending the information includes sending, in response to determining that the respondent is qualified, a link to the third party website to allow the respondent access to the survey.

In Example 5, the subject matter of any one or more of Examples 1-4 optionally include wherein sending the information includes sending, in response to determining that the respondent is not qualified for the survey, a notification to the third party website that the respondent is not qualified.

In Example 6, the subject matter of any one or more of Examples 1-5 optionally include wherein sending the information includes sending targeted product questions instead of survey questions in response to determining that the respondent is qualified to answer the targeted product questions using a cookie received from the third party website corresponding to an advertisement, the targeted product questions including questions about the advertisement.

In Example 7, the subject matter of any one or more of Examples 1-6 optionally include wherein determining that the respondent is qualified for the survey includes determining that answers supplied by the respondent to all of the demographic questions match survey qualification criteria and indicate that the respondent is qualified for the survey.

In Example 8, the subject matter of any one or more of Examples 1-7 optionally include wherein the survey questions are stored at a buyer server and the demographic questions are stored at the host server.

In Example 9, the subject matter of any one or more of Examples 1-8 optionally include automatically creating the demographic questions at the host server by extracting information from a set of requirements provided by a buyer.

In Example 10, the subject matter of any one or more of Examples 1-9 optionally include wherein a first transaction cost is associated with a disqualified respondent and a second transaction cost is associated with a qualified respondent.

In Example 11, the subject matter of any one or more of Examples 1-10 optionally include wherein the third party website is not a dedicated market research website.

Example 12 is a host server for reducing website redirection for surveys comprising: a processor communicatively coupled to memory including instructions, which when executed by the processor, cause the host server to: receive an indication from a third party website via an application programming interface (API), the indication including a request for surveys; supply demographic questions to the third party website from the host server via the API, the demographic questions supplied to be integrated into a webpage of the third party website for display in a Graphical User Interface (GUI) to a respondent; receive an answer to at least one of the demographic questions provided by the respondent on the third party website, the answer sent via the API to the host server; determine whether the respondent is qualified for a survey using the answer; and send, to the third party website, information including a result of the determination.

In Example 13, the subject matter of Example 12 optionally includes wherein to send the information, the processor is to send, in response to determining that the respondent is qualified, survey questions for the survey to the third party website via the API, the survey questions to be integrated into the webpage of the third party website for display in the GUI to the respondent,

In Example 14, the subject matter of Example 13 optionally includes wherein the instructions further cause the processor to receive answers to the survey questions from the third party website.

In Example 15, the subject matter of any one or more of Examples 12-14 optionally. include wherein to send the information, the processor is to send, in response to determining that the respondent is qualified, a link to the third party website to allow the respondent access to the survey.

In Example 16, the subject matter of any one or more of Examples 12-15 optionally include wherein to send the information, the processor is to send, in response to determining that the respondent is not qualified for the survey, a notification to the third party website that the respondent is not qualified.

In Example 17, the subject matter of any one or more of Examples 12-16 optionally include wherein to send the information, the processor is to send targeted product questions instead of survey questions in response to determining that the respondent is qualified to answer the targeted product questions using a cookie received from the third party website corresponding to an advertisement, the targeted product questions including questions about the advertisement.

In Example 18, the subject matter of any one or more of Examples 12-17 optionally include wherein to determine the that the respondent is qualified for the survey, the processor is to determine that answers supplied by the respondent to all of the demographic questions match survey qualification criteria and indicate that the respondent is qualified for the survey.

In Example 19, the subject matter of any one or more of Examples 12-18 optionally. include wherein the survey questions are stored at a buyer server and the demographic questions are stored at the host server.

In Example 20, the subject matter of any one or more of Examples 12-19 optionally include wherein the instructions further cause the processor to automatically create the demographic questions at the host server by extracting information from a set of requirements provided by a buyer.

In Example 21, the subject matter of any one or more of Examples 12-20 optionally include wherein a first transaction cost is associated with a disqualified respondent and a second transaction cost is associated with a qualified respondent.

In Example 22, the subject matter of any one or more of Examples 12-21 optionally include wherein the third party website is not a dedicated market research website.

Example 23 is a machine-readable medium including instructions for reducing website redirection for surveys, which when executed by a processor of a host server, cause the processor to: receive an indication from a third party website via an application programming interface (API), the indication including a request for surveys; supply demographic questions to the third party website from the host server via the API, the demographic questions supplied to be integrated into a webpage of the third party website for display in a Graphical User Interface (GUI) to a respondent; receive an answer to at least one of the demographic questions provided by the respondent on the third party website, the answer sent via the API to the host server; determine whether the respondent is qualified for a survey using the answer; and send, to the third party website, information including a result of the determination.

In Example 24, the subject matter of Example 23 optionally includes wherein the instructions to send the information include instructions to send, in response to determining that the respondent is qualified, survey questions for the survey to the third party website via the API, the survey questions to be integrated into the webpage of the third party website for display in the GUI to the respondent.

In Example 25, the subject matter of Example 24 optionally includes instructions to receive answers to the survey questions from the third party website.

In Example 26, the subject matter of any one or more of Examples 23-25 optionally include wherein the instructions to send the information include instructions to send, in response to determining that the respondent is qualified, a link to the third party website to allow the respondent access to the survey.

In Example 27, the subject matter of any one or more of Examples 23-26 optionally include wherein the instructions to send the information include instructions to send, in response to determining that the respondent is not qualified for the survey, a notification to the third party website that the respondent is not qualified.

In Example 28, the subject matter of any one or more of Examples 23-27 optionally include wherein the instructions to send the information include instructions to send targeted product questions instead of survey questions in response to determining that the respondent is qualified to answer the targeted product questions using a cookie received from the third party website corresponding to an advertisement, the targeted product questions including questions about the advertisement.

In Example 29, the subject matter of any one or more of Examples 23-28 optionally include wherein the instructions to determine that the respondent is qualified for the survey include instructions to determine that answers supplied by the respondent to all of the demographic questions match survey qualification criteria and indicate that the respondent is qualified for the survey.

In Example 30, the subject matter of any one or more of Examples 23-29 optionally include wherein the survey questions are stored at a buyer server and the demographic questions are stored at the host server.

In Example 31, the subject matter of any one or more of Examples 23-30 optionally include instructions to automatically create the demographic questions at the host server by extracting information from a set of requirements provided by a buyer.

In Example 32, the subject matter of any one or more of Examples 23-31 optionally include wherein a first transaction cost is associated with a disqualified respondent and a second transaction cost is associated with a qualified respondent.

In Example 33, the subject matter of any one or more of Examples 23-32 optionally include wherein the third party website is not a dedicated market research website.

Example 34 is a method for reducing website redirection for surveys on mobile devices comprising: receiving, at a host server, an indication from a mobile app via an application programming interface (API), the indication including a request for surveys; supplying demographic questions to the mobile app from the host server via the API, the demographic questions supplied to be integrated into the mobile app for display to a respondent; receiving, at the host server, an answer to at least one of the demographic questions provided by the respondent on the mobile app, the answer sent via the API to the host server; determining, at the host server, whether the respondent is qualified for a survey using the answer; and sending, to the mobile app, information including a result of the determination.

In Example 35, the subject matter of Example 34 optionally includes wherein sending the information includes sending, in response to determining that the respondent is qualified, survey questions for the survey to the mobile app via the API, the survey questions to be integrated into the mobile app for display in the GUI to the respondent.

In Example 36, the subject matter of Example 35 optionally includes receiving answers to the survey questions from the mobile app.

In Example 37, the subject matter of any one or more of Examples 34-36 optionally include wherein sending the information includes sending, in response to determining that the respondent is qualified, a link to the mobile app to allow the respondent access to the survey.

In Example 38, the subject matter of any one or more of Examples 34-37 optionally include wherein sending the information includes sending, in response to determining that the respondent is not qualified for the survey, a notification to the mobile app that the respondent is not qualified.

In Example 39, the subject matter of any one or more of Examples 34-38 optionally include wherein sending the information includes sending targeted product questions instead of survey questions in response to determining that the respondent is qualified to answer the targeted product questions using a cookie received from the mobile app corresponding to an advertisement, the targeted product questions including questions about the advertisement.

In Example 40, the subject matter of any one or more of Examples 34-39 optionally include wherein determining that the respondent is qualified for the survey includes determining that answers supplied by the respondent to all of the demographic questions match survey qualification criteria and indicate that the respondent is qualified for the survey.

In Example 41, the subject matter of any one or more of Examples 34-40 optionally include wherein the survey questions are stored at a buyer server and the demographic questions are stored at the host server.

In Example 42, the subject matter of any one or more of Examples 34-41 optionally include automatically creating the demographic questions at the host server by extracting information from a set of requirements provided by a buyer.

In Example 43, the subject matter of any one or more of Examples 34-42 optionally include wherein a first transaction cost is associated with a disqualified respondent and a second transaction cost is associated with a qualified respondent.

In Example 44, the subject matter of any one or more of Examples 34-43 optionally include wherein the mobile app is not a dedicated market research mobile app.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for reducing website redirection for surveys comprising:
receiving, at a host server, an indication from a third party website via an application programming interface (API), the indication including a request for surveys;
supplying demographic questions to the third party website from the host server via the API, the demographic questions supplied to be integrated into a webpage of the third party website for display in a Graphical User Interface (GUI) to a respondent;
receiving, at the host server, an answer to at least one of the demographic questions provided by the respondent on the third party website, the answer sent via the API to the host server;
determining, at the host server, whether the respondent is qualified for a survey using the answer; and
sending, to the third party website, information including a result of the determination.

2. The method of claim 1, wherein sending the information includes sending, in response to determining that the respondent is qualified, survey questions for the survey to the third party website via the API, the survey questions to he integrated into the webpage of the third party website for display in the GUI to the respondent.

3. The method of claim 2, further comprising receiving answers to the survey questions from the third party website.

4. The method of claim 1, wherein sending the information includes sending, in response to determining that the respondent is not qualified for the survey, a notification to the third party website that the respondent is not qualified.

5. The method of claim 1, wherein sending the information includes sending targeted product questions instead of survey questions in response to determining that the respondent is qualified to answer the targeted product questions using a cookie corresponding to an advertisement, the targeted product questions including questions about the advertisement.

6. The method of claim 1, wherein determining that the respondent is qualified for the survey includes determining that answers supplied by the respondent to all of the demographic questions match survey qualification criteria and indicate that the respondent is qualified for the survey.

7. The method of claim 1, wherein the survey questions are stored at a buyer server.

8. The method of claim 1, further comprising automatically creating the demographic questions at the host server by extracting information from a set of requirements provided by a buyer.

9. The method of claim 1, wherein a first transaction cost is associated with a disqualified respondent and a second transaction cost is associated with a qualified respondent.

10. The method of claim 1, wherein the third party website is not a dedicated market research website.

11. A host server for reducing website redirection for surveys comprising:
a processor communicatively coupled to memory including instructions, which when executed by the processor, cause the host server to:
receive an indication from a third party website via an application programming interface (API), the indication including a request for surveys;
supply demographic questions to the third party website from the host server via the API, the demographic questions supplied to be integrated into a webpage of the third party website for display in a Graphical User Interface (GUI) to a respondent;
receive an answer to at least one of the demographic questions provided by the respondent on the third party website, the answer sent via the API to the host server;
determine whether the respondent is qualified for a survey using the answer; and
send, to the third party website, information including a result of the determination.

12. The host server of claim 11, wherein to send the information, the processor is to send, in response to determining that the respondent is qualified, survey questions for the survey to the third party website via the API, the survey questions to be integrated into the webpage of the third party website for display in the GUI to the respondent.

13. The host server of claim 12, wherein the instructions further cause the processor to receive answers to the survey questions from the third party website.

14. The host server of claim 11, wherein the third party website is not a dedicated market research website.

15. The host server of claim 11, wherein the survey questions are stored at a buyer server.

16. A machine-readable medium including instructions for reducing website redirection for surveys, which when executed by a processor of a host server, cause the processor to:
receive an indication from a third party website via an application programming interface (API), the indication including a request for surveys;
supply demographic questions to the third party website from the host server via the API, the demographic questions supplied to be integrated into a webpage of the third party website for display in a Graphical User Interface (GUI) to a respondent;
receive an answer to at least one of the demographic questions provided by the respondent on the third party website, the answer sent via the API to the host server;
determine whether the respondent is qualified for a survey using the answer; and
send, to the third party website, information including a result of the determination.

17. The machine-readable medium of claim 16, wherein the instructions to send the information include instructions to send, in response to determining that the respondent is qualified, survey questions for the survey to the third party website via the API, the survey questions to be integrated into the webpage of the third party website for display in the GUI to the respondent.

18. The machine-readable medium of claim 17, further comprising instructions to receive answers to the survey questions from the third party website.

19. A method for reducing website redirection for surveys on mobile devices comprising:
receiving, at a host server, an indication from a mobile app via an application programming interface (API), the indication including a request for surveys;
supplying demographic questions to the mobile app from the host server via the API, the demographic questions supplied to be integrated into the mobile app for display to a respondent;
receiving, at the host server, an answer to at least one of the demographic questions provided by the respondent on the mobile app, the answer sent via the API to the host server;
determining, at the host server, whether the respondent is qualified for a survey using the answer; and
sending, to the mobile app, information including a result of the determination.

20. The method of claim 19, wherein sending the information includes sending, in response to determining that the respondent is qualified, survey questions for the survey to the mobile app via the API, the survey questions to be integrated into the mobile app for display in the GUI to the respondent.
